(19) United States
(12) Patent Application Publication
(10) Pub. No.: US 2009/0268212 A1
(43) Pub. Date: Oct. 29, 2009

(54) MOIRE SHAPE MEASUREMENT APPARATUS USING LIQUID CRYSTAL DISPLAY PANEL

(76) Inventors: Kuk-Won Ko, Seongnam-si (KR); Kyoung-Chul Koh, Asan-si (KR)

Correspondence Address: SHERR & VAUGHN, PLLC, 620 HERNDON PARKWAY, SUITE 320, HERNDON, VA, 20170, US

(21) Appl. No.: 12/388,368

(22) Filed: Feb. 18, 2009

(30) Foreign Application Priority Data
Mar. 24, 2008 (KR) 10-2008-0026940

(51) Int. Cl. G01B 11/25

(52) U.S. Cl. 356/511

(57) ABSTRACT

Disclosed herein is a moiré shape measurement apparatus using a Liquid Crystal Display (LCD) panel. The moiré shape measurement apparatus includes a light source, a variable grating, a viewing lens, a light receiving unit, a computation unit, and a driving device. The light source emits light. The variable grating passes the emitted light therethrough, and creates a projection grating pattern. The viewing lens focuses a reflected grating pattern that is obtained when the projection grating pattern is reflected from the object. The light receiving unit receives the light of the reflected grating pattern passed through the viewing lens. The computation unit previously stores the viewing grating pattern, forms the moiré pattern by overlaying the reflected grating pattern, received from the light receiving unit, on the stored viewing grating pattern, and computes the shape of the object using the moiré pattern. The driving device adjusts a direction and a pitch in order to form a grating of the variable grating.

### BACKGROUND OF THE INVENTION

1. Field of the Invention

The present invention relates to a shape measuring apparatus using a moiré pattern.

2. Description of the Related Art

In general, a moiré pattern is a pattern that is created when two or more grating patterns having specific spatial frequencies are overlaid on each other. In this case, when a grating is projected onto an object to be measured, the grating is deformed due to the shape of the object. When the deformed grating is overlaid on another grating having a similar frequency, a moiré pattern corresponding to the height of the object is created.

Such a moiré pattern is created when two or more periodic patterns are overlaid on each other, and is defined as a kind of interference pattern that has a low frequency, as compared with a viewing pattern. A moiré pattern having an intrinsic low frequency, which is explained by the beat phenomenon, is widely used in various engineering fields ranging from the measurement of two-dimensional (2D) displacements to the measurement of three-dimensional (3D) shapes.

Various types of research into the moiré phenomenon have been conducted by various persons since the moiré phenomenon was first proposed as a scientific tool by Lord Rayleigh in 1874. In particular, a method using the moiré phenomenon has strengthened its position in the field of mechanical engineering as a tool useful for the analysis of the strain of an object, ever since the moiré phenomenon was used to measure the planar (in-plane) displacement of an object. A three-dimensional shape measuring method using the moiré phenomenon has attracted attention since it was proposed by Meadows and Takasaki in 1970 that the moiré phenomenon could be used to measure the 3D (out-of-plane) shape of an object having an arbitrary shape. A moiré method is divided into a shadow moiré method and a projection moiré method according to the method of forming the moiré pattern. In the case in which a target object has many specular properties, 3D shapes can be measured using a reflection moiré method.

The projection moiré method is a method of obtaining a moiré pattern by scanning a grating pattern onto an object to be measured using a white light or monochromatic light projector and overlaying an image of the grating, deformed depending on the shape of the object, on a viewing grating having the same pitch as the scanned grating.

FIG. 1A is a diagram showing the construction of a conventional projection moiré shape measurement apparatus using two gratings.

Referring to FIG. 1A, the moiré shape measurement apparatus is basically divided into a projection system 10 for projecting a projection grating and a viewing system 20 for forming an image of the projected grating.

In general, a white light source is used as a light source 11. A condenser lens 12 for uniformly condensing the light of the light source onto a grating surface is located between the light source 11 and a projection grating 13. The same linear gratings having the same pitch are used as a projection grating 13 and a viewing grating 17, respectively. These two gratings are symmetrically located in the same plane 23 that is perpendicular to two optical axes 21 and 22. The projection grating 13, illuminated by uniform light passed through the condenser lens 12, is projected onto an object 15 to be measured through a projection lens 14. The projected linear grating is deformed due to the height of the object 15 to be measured, and the deformed grating is focused on the viewing grating 17 through the viewing lens 16. Here, a moiré pattern is formed on the viewing grating 17, and is finally formed on a light receiving element 19 through a relay lens 18. In order for the equi-order plane of the moiré pattern to be planar in this optical system, the optical axis 21 of the projection system and the optical axis 22 of the viewing system must be parallel, and the two lenses must be located in a single plane 24 perpendicular to the two optical axes. That is, in the projection system 10 and the viewing system 20, gratings and lenses must be arranged symmetrical with respect to an arbitrary axis that is parallel to optical axes. The above-described example is an example of using the same linear gratings having the same pitch, while an example of using a variable pitch is illustrated in FIG. 1B.

FIG. 1B is a diagram showing the construction of a conventional moiré shape measurement apparatus using two gratings.

Referring to FIG. 1B, macro-lenses having a focal distance of 60 mm capable of minimizing error attributable to the aberration and distortion of another lens are used as a projection lens 51 and a viewing lens 52. Furthermore, as described above, the projection lens 51 and the viewing lens 52 are located in a single plane 61. A multi-phase shift grating 53 in which phase shift gratings each composed of n pairs of projection/viewing gratings and designed to have slight differences in pitch are overlaid on each other is fabricated in a crystal glass coated with chrome using semiconductor lithography, and is located on an image surface for the macro-lenses. The multi-phase shift grating 53 is driven at a uniform speed by a driving device 58. As the multi-phase shift grating 53 is driven, phase shift is performed in steps and image formation is performed on the image light receiving element, and thus a viewing grating, which acts as an error factor, is eliminated thanks to an averaging effect. A halogen lamp is used as a light source 55. A moiré pattern formed on the viewing grating is focused on the light receiving element 56 through the relay lens 57. This image is sent to an image acquisition device 59 mounted to a computer 60, and a 3D shape is measured using a phase measurement algorithm. Although the multi-phase shift grating used in the above case is designed to have a varying pitch, there is the inconvenience of providing a separate driving device and moving the grating in order to adjust the pitch.

Although in the above-described two embodiments, examples of using two gratings have been described, a conventional moiré shape measurement apparatus using a single grating will be described below with reference to FIG. 2.

Referring to FIG. 2, a single projection grating 300 is moved using grating moving means 500, and a moiré pattern is acquired using an image, received by the light receiving unit 110, and an image, stored in a computer (not shown). Here, a Charge-Coupled Device (CCD) may be used as the light receiving unit 110.

The moiré shape measurement apparatus using a single projection grating has problems in that separate grating moving means must be provided and it is impossible to adjust the direction of the grating although the accuracy of measurement of an object to be measured may vary depending on the direction of inclination of the object to be measured and the direction of inclination of the grating.

### SUMMARY OF THE INVENTION

Accordingly, the present invention has been made keeping in mind the above problems occurring in the prior art, and an object of the present invention is to provide a moiré shape measurement apparatus that is capable of forming a moiré pattern using, instead of a grating, a Liquid Crystal Display (LCD) panel, capable of performing the easy adjustment of directionality and pitch, to form the moiré pattern and perform shape measurement using the moiré pattern.

In order to accomplish the above object, the present invention provides a moiré shape measurement apparatus using an LCD panel, the moiré shape measurement apparatus including a moiré interferometer for previously storing a viewing grating pattern and creating a moiré pattern, and being used to measure a shape of an object, the apparatus including a light source for emitting light; a projection LCD panel for passing the emitted light therethrough and creating a projection grating pattern; a viewing lens for focusing a reflected grating pattern obtained when the projection grating pattern is reflected from the object; a light receiving unit for receiving light of the reflected grating pattern passed through the viewing lens; a computation unit for previously storing the viewing grating pattern, forming the moiré pattern by overlaying the reflected grating pattern, received from the light receiving unit, on the stored viewing grating pattern, and computing the shape of the object using the moiré pattern; and a driving device for adjusting a direction and a pitch in order to form a grating of the projection LCD panel.

The driving device may include a projection LCD panel driving unit for driving the projection LCD panel; a direction control unit for controlling the direction of the projection LCD panel; a pitch adjustment unit for controlling the pitch of the projection LCD panel; and a control unit for performing control so that the direction and pitch of the projection LCD panel can be controlled by controlling the above elements.

The control unit may store the amounts of adjustment of the direction and pitch of liquid crystals, based on voltage control values, in a lookup table.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are diagrams showing the constructions of moiré shape measurement apparatuses using two gratings;

FIG. 2 is a diagram showing the construction of a conventional moiré shape measurement apparatus using a single grating;

FIG. 3 is a diagram showing the construction of a moiré shape measurement apparatus according to an embodiment of the present invention; and

FIG. 4 is a detailed block diagram showing the driving device of the apparatus of FIG. 3.

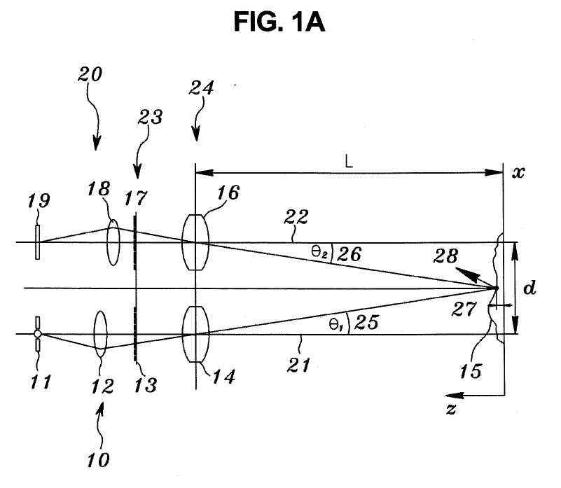

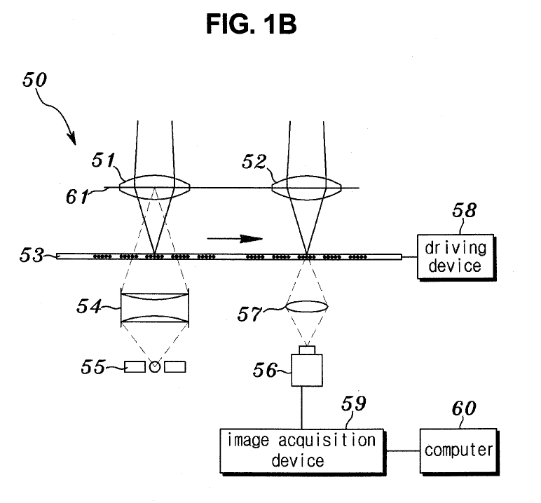

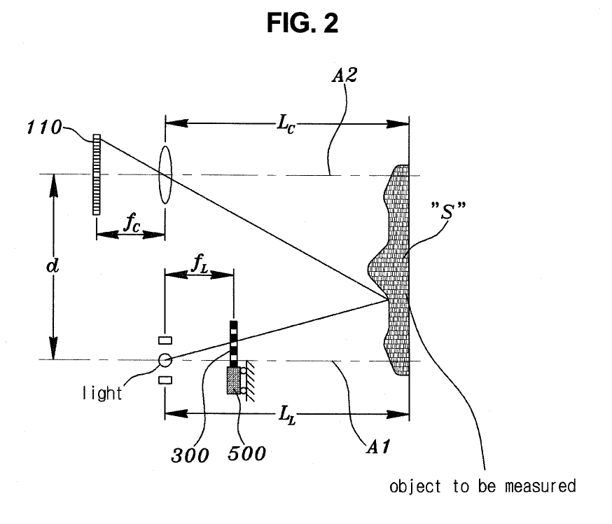

### DESCRIPTION OF THE PREFERRED EMBODIMENTS

Reference now should be made to the drawings, in which the same reference numerals are used throughout the different drawings to designate the same or similar components.

An LCD is a display device that makes use of the properties in which the characteristics of a material, such as the penetration power of light, are changed when an electric field is applied to material that is liquid but exhibits the characteristics of a crystal when viewed from an optical standpoint. In the case of a color display, each pixel of an LCD panel is composed of three liquid crystal cells having a delta arrangement and red, green and blue video signals are output, while in the case of a monochromatic display, pixels are configured to have a stripe arrangement. A display panel is constructed by arranging such pixels in a matrix having column lines and row lines, and text or images are output in response to control signals from a driving circuit. The present invention is used to create a grating using the characteristics of the LCD panel. Since a direction and a pitch are adjusted based on the characteristics of an LCD using the driving circuit of the LCD panel, a pitch can be adjusted without the replacement of a grating, the pitch of which is fixed. Accordingly, in the present invention, the LCD panel can form a moiré pattern by performing the role of a projection grating. It is apparent that the moiré shape measurement apparatus of the present invention can perform direction control and pitch adjustment by changing the arrangement of crystals based on the characteristics of the LCD. In the case in which an LCD panel is employed, as in the following embodiment of the present invention, it is possible to create various gratings using the liquid crystals of an LCD panel without replacing a grating with another because measurement can be performed using the arrangement of the liquid crystals of the LCD, instead of manipulating a grating. In shape measurement, the direction of inclination of an object to be measured and the direction of a created grating pattern govern the accuracy of measurement. In the case in which a grating is formed using an LCD panel, as in the present invention, the direction and the pitch can be freely adjusted, and thus the accuracy of measurement can be improved.

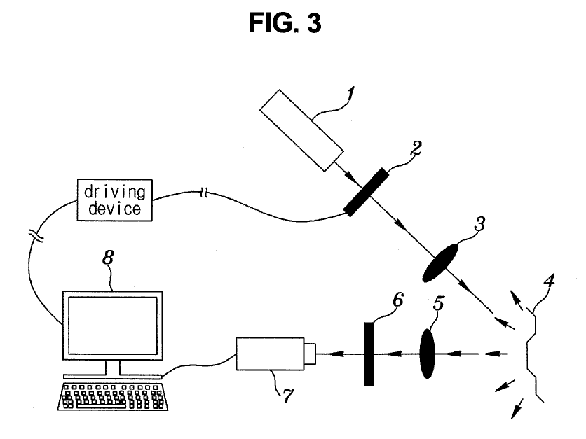

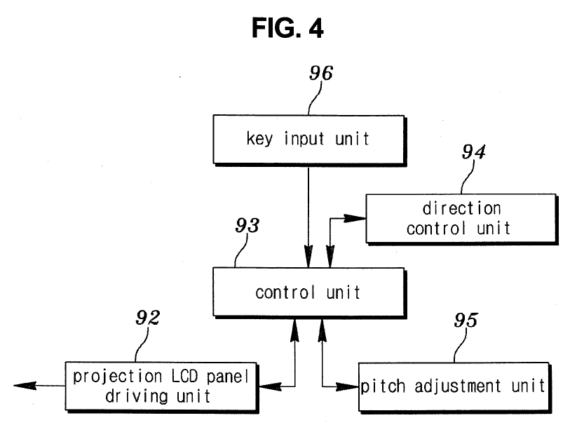

A preferred embodiment of the present invention will be described in detail with reference to the attached FIGS. 3 and 4.

FIG. 3 is a diagram showing the construction of a moiré shape measurement apparatus according to an embodiment of the present invention.

In the apparatus of FIG. 3, an existing moiré interferometer for forming a moiré pattern is used, a grating is replaced with an LCD panel, and a driving device for driving the LCD of the LCD panel is additionally provided.

Referring to FIG. 3, the apparatus includes a projection LCD panel 2 for passing light, emitted from a light source 1, therethrough, a target object 4 configured such that a grating pattern created by the projection LCD panel 2 is projected thereonto, viewing lenses 5 and 6 for forming a grating pattern reflected from the target object 4 to be measured, a light receiving unit 7 for receiving the grating pattern passed through the viewing lenses 5 and 6, a Personal Computer (PC) 8 for previously storing a viewing grating pattern, and for forming a moiré pattern by overlaying a grating pattern on the previously stored viewing grating pattern received from the light receiving unit 7, and a driving device 9 for driving the projection LCD panel 2.

Here, it is preferred that the light source 1 be implemented using a laser diode, which is small, light and inexpensive and is called a semiconductor laser, or a halogen light source.

The light receiving unit 7 is a 2D image sensor. It is preferred that the light receiving unit 7 be a CCD camera.

Furthermore, the projection lens 3 and the viewing lenses 5 and 6 are formed of well-known lenses, respectively.

In FIG. 3, light emitted from the light source 1 is passed through the projection LCD panel 2, is reflected from the target object 4, reaches the light receiving unit 7 through the viewing lenses 5 and 6, and forms an image of a grating pattern, and the PC 8 finally creates a moiré pattern using the grating pattern. Here, the driving device 9 is connected to the projection LCD panel 2 to change the arrangement of the liquid crystals of the projection LCD panel 2, and the driving device 9 is also connected to the PC 8.

First, the driving device 9 applies voltage to the projection LCD panel 2, thereby changing the arrangement of liquid crystals and creating a grating. Meanwhile, when light emitted from the light source 1 is radiated onto the projection LCD panel 2, the emitted light is passed through the projection LCD panel 2 depending on the arrangement of the liquid crystals, and thus light in which a grating pattern is formed, is projected. The light of the grating pattern passed through the projection LCD panel 2 is passed through the lens 3, and is projected onto the object 4. The light of the grating pattern projected onto the object 4 is focused using the viewing lenses 5 and 6, and is received by the light receiving unit 7. The light of the grating pattern reflected from the object 14 and received by the light receiving unit 7 enters the PC 8 in the form of an image pickup signal, and the PC 8 creates a moiré pattern by overlaying the image pickup signal, including the grating pattern, reflected from the object 14, and the image signal of the previously stored viewing grating pattern on each other.

Through the repetition of the above-described process, a moiré pattern including measuring error and a moiré pattern including shape information can be created, and accurate shape measurement can be achieved by correcting the moiré pattern including shape information using the moiré pattern which includes measuring error. When such moiré patterns are obtained using the projection LCD panel 2, the adjustment of a pitch and the determination of the direction of liquid crystals can be performed depending on the amount of voltage applied to the driving device 9, and thus various grating patterns can be obtained using various gratings. Accordingly, in the present embodiment, moiré patterns can be obtained in such a way as to adjust the direction and pitch of liquid crystals by driving the projection LCD panel 2 using the driving device 9.

FIG. 4 is a detailed block diagram showing the driving device of the apparatus of FIG. 3.

Referring to FIG. 4, the driving device 9 includes a projection LCD panel driving unit 92 for driving the projection LCD panel 2, a control unit 93 for controlling the driving of the projection LCD panel 2, a direction control unit 94 for controlling the direction of the projection LCD panel 2, a pitch adjustment unit 95 for adjusting the pitch of the projection LCD panel 2, and a key input unit 96 for inputting a command to drive the projection LCD panel. Here, it is possible to use the keypad of the PC 8, connected to the driving device 9, as the key input unit 96.

In FIG. 4, the key input unit 96 performs key input in order to adjust the direction and pitch of the projection LCD panel 2. The control unit 93 controls the direction control unit 94 and the pitch adjustment unit 95 in compliance with the key input, thereby controlling the projection LCD panel driving unit 92 in order to drive the projection LCD panel 2. The projection LCD panel driving unit 92 applies a voltage value capable of forming the arrangement of liquid crystals having a direction and a pitch as requested by the key input to the projection LCD panel 2. In this case, when a direction or a pitch is controlled or both a direction and a pitch are controlled in order to form a desired grating on the projection LCD panel 2, the projection LCD panel driving unit 92 can adjust the direction and pitch of a grating by changing the arrangement of liquid crystals in such a way as to adjust a voltage value to an appropriate voltage value to be applied under the control of the control unit 93. The control unit 93 stores the amounts of adjustment of the direction and pitch of liquid crystals, based on voltage control values, in a lookup table, and outputs a relevant voltage control value, stored in the lookup table, to the projection LCD panel driving unit 92 in response to key input from the key input unit 96.

When the driving of the projection LCD panel driving unit 92 is controlled, a desired grating can be obtained because the direction and pitch of the projection LCD panel 2 can be adjusted, and thus a moiré pattern can be formed.

Accordingly, since the apparatus of the present invention employs an LCD panel, instead of a grating, in order to form a moiré pattern, the present invention provides an effect of facilitating the adjustment of the direction and pitch of a grating.

Furthermore, since a moiré pattern is formed using the LCD panel, the present invention allows for forming a grating pattern having a desired direction and pitch by changing the arrangement of liquid crystals based on the characteristics of the LCD panel without changing the location of the panel itself.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-4. (canceled)

5. A moiré shape measurement apparatus using a liquid crystal display panel to measure a shape of an object, the moiré shape measurement apparatus including a moiré interferometer for storing a viewing grating pattern and creating a moiré pattern, the apparatus comprising:
a light source for emitting light;
a variable grating for passing the emitted light therethrough and creating a projection grating pattern;
a viewing lens for focusing a reflected grating pattern obtained when the projection grating pattern is reflected from an object;
a light receiving unit for receiving light of the reflected grating pattern from the viewing lens;
a computation unit for storing a viewing grating pattern, forming a moiré pattern by overlaying the reflected grating pattern, received from the light receiving unit, on the stored viewing grating pattern, and computing the shape of the object using the moiré pattern; and
a driving device for adjusting a direction and a pitch in order to form a grating of the variable grating.

6. The moiré shape measurement apparatus as set forth in claim 5, wherein the variable grating is a projection liquid crystal display panel.

7. The moiré shape measurement apparatus as set forth in claim 6, wherein the driving device comprises:
a projection liquid crystal display panel driving unit for driving the projection liquid crystal display panel;
a direction control unit for controlling the direction of the projection liquid crystal display panel;
a pitch adjustment unit for controlling the pitch of the projection liquid crystal display panel; and
a control unit for performing control so that the direction and pitch of the projection liquid crystal display panel can be controlled by controlling the projection liquid crystal display panel driving unit, the direction control unit, and the pitch adjustment unit.

8. The moiré shape measurement apparatus as set forth in claim 7, wherein the control unit stores amounts of adjustment of the direction and pitch of liquid crystals, based on voltage control values, in a lookup table.
